(19) United States
(12) Patent Application Publication
(10) Pub. No.: US 2008/0135520 A1
(43) Pub. Date: Jun. 12, 2008

(54) Chemical composition for chemical mechanical planarization

(76) Inventor: Tao Sun, Arcadia, CA (US)

Correspondence Address: FULWIDER PATTON LLP, HOWARD HUGHES CENTER, 6060 CENTER DRIVE, TENTH FLOOR, LOS ANGELES, CA, 90045, US

(21) Appl. No.: 11/637,536

(22) Filed: Dec. 12, 2006

(51) Int. Cl. C09K 13/00; C03C 15/00

(52) U.S. Cl. 216/89; 252/79.1

(57) ABSTRACT

The chemical composition for a slurry for chemical mechanical planarization includes abrasive particles selected from the group consisting of SiO₂, Al₂O₃, TiO₂, and CeO₂, and combinations thereof, and a silicate oligomer as a rate accelerator. The slurry may include an organic dispersion agent, and preferably has a has a pH in the range of about 4 to about 12.

### BACKGROUND OF THE INVENTION

The present invention generally relates to polishing compositions, and more particularly relates to a new composition for a polishing slurry for substrates, including silicon and silicon-containing substrates, such as silicon wafers, silicon oxides, silicates, and glass surfaces, as well as semi-conductor surfaces, such as gallium arsenide, germanium, indium tin oxide, other semiconducting materials, and other oxide surfaces.

Techniques for chemical mechanical planarization (CMP) have been developed to polish the surface of materials such as semiconductor wafers, silicon oxides, silicates, glass surfaces and the like, and typically involve rotating the surface of the material to be polished on a polishing pad, applying pressure through a rotating chuck, and supplying an aqueous chemical slurry containing an abrasive polishing agent and surfactants to the polishing pad. Abrasive agents that have been used in the chemical mechanical slurry include abrasive particles of fumed or colloidal silica, ceria, alumina and other appropriate compositions. The chemical mechanical planarization slurry can also include stabilizer or oxidizer agents. Silica is typically mixed with a stabilizer such as potassium hydroxide or ammonium hydroxide, and is commonly used to polish dielectric or oxide layers on semiconductor wafers. Ceria and alumina are commonly mixed with an oxidizer agent such as ferric nitrate or hydrogen peroxide, and have also been used to polish metal layers, such as tungsten, copper and aluminum, for example. One conventional ceria-based CMP slurry for polishing patterned oxides on a substrate, for example, includes ceria particles having a concentration of 1.0 to 5.0 wt % and silica particles having a concentration of 0.1 to 5.0 wt %, with a ratio of ceria concentration to silica concentration from approximately 10:1 to nearly 1:1 by weight.

Ceria based polishing powders have traditionally been used for glass related polishing. A good dispersion of cerium oxide in a polishing slurry, and control of pH and other parameters can be difficult to achieve, but can be quite critical for consistent polishing performance, especially on a final polished surface that requires very high surface precision. In addition, the fluid flow properties of current glass polishing slurries are typically very poor, often leading to rapid development of a significant slurry deposit on polishing pads and polishing machines. Rapid deposition of polishing powder on polishing pads with removed glass substrate materials also leads to deteriorated polished surface finishes. Very often the polishing machine needs to be shut down so that deposited ceria powder can be cleaned up, leading to lower productivity. As a result, current commercial glass polishing slurries typically have poor consistency, achieve low productivity, and can cause significant down time for polishing machine maintenance. Ceria polishing compounds are also difficult to adjust for different glass substrates that have very distinct compositions. Current ceria polishing powder is also more mechanically oriented than chemical, and therefore tends to produce more scratch defects. It would therefore be desirable to provide a chemical composition to be used as a slurry for chemical mechanical planarization of silicon oxides, silicates, glass surfaces and the like, to provide a higher removal rate, reduction of scratch defects, and good suspension of the slurry. The present invention meets these and other needs.

### SUMMARY OF THE INVENTION

Briefly, and in general terms, the present invention provides for a chemical composition for a slurry for chemical mechanical planarization of silicon, silicon oxides, silicates, glass surfaces, gallium arsenide, indium tin oxide, other semiconducting materials and the like. The slurry includes abrasive particles selected from the group consisting of SiO₂, Al₂O₃, TiO₂, and CeO₂, and combinations thereof, and a silicate oligomer as a rate accelerator. In a presently preferred aspect, the silicate oligomer is selected from the group consisting of hydrolysates and condensates of silicates, silicon alkoxides, or precipitated silica, and combinations thereof. In a presently preferred aspect, the concentration of abrasive particles in the slurry is less than 50% by weight, and most preferably less than approximately 30% by weight; and the concentration of silicate oligomer in the slurry is less than 50% by weight, and most preferably less than approximately 30% by weight.

In a presently preferred aspect, the slurry further includes a surfactant additive, or organic dispersion agent or film forming agent, which may be at least one water soluble ionic polymer or nonionic polymer with molecular weights selected preferably lower than 15,000 daltons. In one presently preferred aspect the surfactant additive may be selected from the group consisting of phosphate or phosponic surfactants, organophosphate polymers, organophosphane polymers, silicone surfactants, ammonium surfactants, polyethylene oxide, polypropylene oxide (PO), ethylene oxide (EO), polypropylene oxide-ethylene oxide (EO-PO) copolymers, polypropylene oxide alkyl or block polypropylene oxide-ethylene oxide (PO-EO) surfactants, polyacrylate (PA), poly(methyl acrylate) (PMA), poly(methyl methacrylate) (PMMA), polyacrylamide (PAM), polyurethane (PU), and combinations thereof. The slurry preferably has a basic pH, and in a presently preferred aspect, the slurry has a pH from about 6 to about 10. The slurry may optionally include an oxidizer.

The present invention also provides for a method of preparing a slurry for performing chemical mechanical planarization of silicon, silicon oxides, silicates, glass surfaces, gallium arsenide, indium tin oxide, other semiconducting materials and the like. In the method of preparing a slurry, water, abrasive particles and a silicate oligomer are mixed to form a mixture. In a presently preferred aspect, the concentration of abrasive particles in the slurry is less than about 50% by weight, the concentration of silicate oligomer in the slurry is less than about 50% by weight, and the concentration of water in the slurry is from about 20% to about 99% by weight. In another presently preferred aspect, the abrasive particles are selected from the group consisting of SiO₂, Al₂O₃, TiO₂, and CeO₂, and combinations thereof. The pH of the mixture is adjusted to a pH in the range of about 10 to 11, and the mixture is heated to a temperature of about 80° C. or less. In a presently preferred embodiment, the mixture is heated to a temperature of about 60° C. or less, and the temperature of the mixture is maintained at about 60° C. from about 0.1-6 hours. The mixture is then cooled to approximately ambient temperature, and the pH of the mixture is adjusted to about 4 to 12 to form the slurry.

The present invention also provides for a method of polishing a surface of a silicon oxide, silicate, or glass substrate with a slurry for performing chemical mechanical planarization. The method of polishing a surface involves providing a slurry comprising abrasive particles selected from the group consisting of SiO₂, Al₂O₃, TiO₂, and CeO₂, and combinations thereof; a silicate oligomer as a rate accelerator; and water; applying the slurry to a polishing pad; and polishing the surface of the substrate with the slurry and the polishing pad. In a presently preferred aspect, the concentration of abrasive particles in the slurry is less than about 50% by weight, the concentration of silicate oligomer in the slurry is less than about 50% by weight, and the concentration of water in the slurry is from about 20% to about 99% by weight.

Other features and advantages of the present invention will become more apparent from the following detailed description and examples of the preferred embodiments.

### DETAILED DESCRIPTION OF THE PREFERRED EMBODIMENTS

Control of dispersions of ceria in ceria based slurries and control of fluid flow properties of such slurries have previously posed challenges when used for glass related polishing, typically resulting in rapid development of a significant slurry deposit on polishing pads and polishing machines, and excessive down time for cleaning of deposited ceria powder from polishing pads and polishing machines. In addition, a strong mechanical polishing contribution often leads to production of a poor surface finish.

The present invention accordingly provides for a new polishing composition for a polishing slurry for silicon oxides, silicates, and glass surfaces. The invention provides a high stock material removal rate, as well as a very high planarization efficiency with significant reduction of scratch defects. The composition includes a hard particle selected from silicon dioxide (SiO₂), aluminum oxide (Al₂O₃), titanium dioxide (TiO₂), cerium dioxide (CeO₂), and the like, and combinations thereof, and one or more silicate oligomers as a rate accelerator, which typically increases the planarization rate more than 30%. In a presently preferred aspect, the concentration of abrasive particles in the slurry is about 0.001% to about 50% by weight, and most preferably less than approximately 30% by weight; and the concentration of silicate oligomer in the slurry is about 0.1% to about 50% by weight, and most preferably less than approximately 30% by weight.

The silicate oligomer may be an oligomeric polysilicate, preferably selected from the group consisting of hydrolysis and condensation of silicates, silicon alkoxides, or precipitated silica, and combinations thereof. In a presently preferred embodiment, the silicate oligomer is provided by water glass (sodium silicate, or potassium silicate). Oligomeric polysilicates such as sodium or potassium disilicate or other disilicate salts, sodium or potassium trisilicate or other trisilicate salts, sodium or potassium tetrasilicate or other tetrasilicate salts, or cyclic polysilicates, and combinations thereof, may also be suitable.

One or more surfactant or polymer additives, used as dispersant or dispersion agents or film forming agents, may be added to improve the fluidity of the polishing slurry, leading to less slurry deposition on the polishing pad and polishing machine, as well as a lower rate of scratch defects. In general, the surfactant additives can be selected from alkylsphosphonates, alkylphosphates, polyamines, alkylpolyethylene (polypropylene) oxides, or ethylene or propylene oxide block polymers, polyacrylates, polyamides, alkylammonium salts, polyethylene oxide silicone surfactants, or their mixtures, and the like. Preferably the dispersant can be selected from water soluble ionic and nonionic polymers with molecular weights selected preferably lower than 15,000 daltons, such as phosphate or phosponic surfactants, organophosphate polymers, organophosphane polymers, silicone surfactants, ammonium surfactants, polyethylene oxide, polypropylene oxide (PO), ethylene oxide (EO), polypropylene oxide-ethylene oxide (EO-PO) copolymers, polypropylene oxide alkyl or block polypropylene oxide-ethylene oxide (PO-EO) surfactants, polyacrylates (PA), polyamides, poly(methyl acrylate) (PMA), poly(methyl methacrylate)(PMMA), polyacrylamide (PAM) and the like, and combinations thereof. Other surfactants that may also be suitable include nonionic surfactants such as alkanoamide, alkylphenol polyethylene oxide, polyoxyethylenated alkyl amine oxide, polyoxyethylenated polyoxypropylene glycols, alkyl polyglucoside, alkyl carboxylic acid esters, polyoxyethylenated mercaptans, alkyl diglyceride, polyoxyethylenated alkanolamine, polyalkoxylated amides, tertiary acetylenic glycols and mixtures thereof. The concentration of the dispersant can be from about 0.0001% to about 20% by weight.

In the method of preparing a slurry for performing chemical mechanical planarization of silicon, silicon oxides, silicates, glass surfaces, gallium arsenide, indium tin oxide, other semiconducting materials and the like, an initial mixture is formed by mixing together water, abrasive particles and a silicate oligomer. In a presently preferred aspect, the concentration of abrasive particles in the slurry is less than about 50% by weight, the concentration of silicate oligomer in the slurry is less than about 50% by weight, and the concentration of water in the slurry is from about 20% to about 99% by weight. In another presently preferred aspect, the abrasive particles are selected from the group consisting of SiO₂, Al₂O₃, TiO₂, and CeO₂, and combinations thereof. The pH of the mixture is adjusted to a pH in the range of about 10 to 11, and the mixture is heated to a temperature of about 80° C. or less. In a presently preferred embodiment, the mixture is heated to a temperature of about 60° C. or less, and the temperature of the mixture is maintained at about 60° C. from about 0.1-6 hours. The mixture is then cooled to approximately ambient temperature, and the pH of the mixture is adjusted to about 4 to 12 to form the slurry.

The method of preparing a slurry for performing chemical mechanical planarization according to the invention can be practiced in a very broad pH range of from about 4 to about 12, but is preferably in the neutral to basic pH range of about 6 or 7 to about 10, depending on the selection of abrasives, oxidizers, and dispersing agents in the polishing slurry. Optimal pH is about 10. A stabilizer such as potassium hydroxide or ammonium hydroxide may optionally be included in the slurry, and up to 5% by weight of an oxidizer such as perborate, persulfate, periodate, permanganate, urea-peroxide, hydroxylamine, or combinations thereof, also may optionally be included in the slurry, although ferric nitrate or hydrogen peroxide may also be suitable.

In the method according to the invention for polishing a surface of a silicon oxide, silicate, or glass substrate with a slurry for performing chemical mechanical planarization, a slurry is provided comprising abrasive particles selected from the group consisting of SiO₂, Al₂O₃, TiO₂, and CeO₂, and combinations thereof; a silicate oligomer as a rate accelerator; and water. The slurry is applied to a polishing pad; and the surface of the substrate is polished with the slurry and the polishing pad. In a presently preferred aspect, the concentration of abrasive particles in the slurry is less than about 50% by weight, the concentration of silicate oligomer in the slurry is less than about 50% by weight, and the concentration of water in the slurry is from about 20% to about 99% by weight.

### EXAMPLE 1

To 4517 grams of deionized water, 600 grams of cerium oxide particles with a median diameter (D50) of about 1.3 μm was added under mechanical agitation at ambient temperature and pressure conditions. 333 grams of water glass (sodium silicate with a Na₂O/SiO₂ mole ratio of 2:1) was introduced into the suspension at ambient temperature with good mechanical agitation to provide a homogeneous suspension. Then phosphonic acid was used to adjust the pH of the suspension to about 10. The mixture was heated to about 60° C., and was maintained at about 60° C. for 6 hours. The mixture was then cooled to ambient temperature, and the pH of the resulting preliminary slurry was adjusted with potassium hydroxide to a desired pH of about 11.

To improve the suspension properties and fluidity of the slurry, 0.15 grams, 1.5 grams, 3 grams, and 15 grams of octyl/decyl phosphate surfactant additive was introduced into a batch of the preliminary slurry formed in the foregoing manner, to make resultant polishing slurries A, B, C and D, respectively.

The resultant polishing slurries A, B, C and D were used for glass polishing on a SpeedFam 9B double-side polisher. Down force was 0.1 kg/cm², lower platen speed was 30 RPM, and the slurry flow rate was 200 ml/min. The glass removal rate of these polishing slurries was 612, 631, 655, and 650 nm/min, respectively. There were no surface scratches and no slurry deposit on polishing machine or polishing pads.

### EXAMPLE 2

To 3984 grams of deionized water, 350 grams of cerium oxide with a median diameter (D50) of about 1.3 μm was added, under agitation at ambient conditions. The mixture was continuously mixed for 15 minutes to make a homogeneous suspension. To the suspension, 666 grams of water glass (sodium silicate with a mole ratio of 2:1) was introduced at ambient temperature. Then hydrochloric acid was used to adjust the pH of the suspension to about 11. The resulting mixture was heated to 60° C. under autogenous conditions, and maintained at 60° C. for 2 hrs. The prepared slurry was then cooled to ambient temperature, and the pH was adjusted to about 4 using hydrochloric acid.

The resultant polishing slurry was used for glass polishing on a SpeedFam 9B double-side polisher. Down force was 0.1 kg/cm², lower platen speed was 30 RPM, and the slurry flow rate was 200 ml/min. The glass removal rate of the polishing slurry was 539 nm/min. There were no surface scratches, and no slurry deposit on the polishing machine or the polishing pads.

The resultant polishing slurry was also used for silicon wafer polishing on a Logitech CDP polisher. Down force was 1 psi, the lower platen speed and carrier speed were 50 RPM, and the slurry flow rate was 100 ml/min. The silicon wafer polishing removal rate was 247 nm/min.

### EXAMPLE 3

A: To 4933 g of deionized water, 0.05 grams of cerium oxide with a median diameter (D50) of about 1.3 μm was added, under agitation at ambient conditions. The mixture was continuously mixed for 15 minutes to make a homogeneous suspension. To the suspension, 67 g of water glass (sodium silicate with a mole ratio of 2:1) was introduced at ambient temperature. Then hydrochloric acid was used to adjust the pH to about 11. The resultant mixture was heated to 60° C. under autogenous conditions, and maintained at 60° C. for 2 hrs. Then the prepared slurry was cooled to ambient temperature, and the pH was adjusted to about 9 using hydrochloric acid.

B: To 1167 grams of deionized water, 2500 grams of cerium oxide with a median diameter (D50) of about 1.3 μm was added, under agitation at ambient conditions. The mixture was continuously mixed for 15 minutes to make a homogeneous suspension. To the suspension, 1333 grams of water glass (potassium silicate with a mole ratio of 2:1) was introduced at ambient temperature. Then hydrochloric acid was used to adjust the pH to about 11. The resultant mixture was heated to 60° C. under autogenous conditions, and maintained at 60° C. for 2 hrs. Then the prepared slurry was cooled to ambient temperature, and the pH was adjusted to about 9 using hydrochloric acid. 200 grams of the above prepared sample was added to 1800 g of water with agitation, and was used for polishing.

C: To 4645 grams of deionized water, 350 grams of cerium oxide with a median diameter (D50) of about 1.3 μm was added, under agitation at ambient conditions. The mixture was continuously mixed for 15 minutes to make a homogeneous suspension. To the suspension, 5 grams of water glass (potassium silicate with a mole ratio of 2:1) was introduced at ambient temperature. Then hydrochloric acid was used to adjust the pH to about 11. The resultant mixture was heated to 60° C. under autogenous conditions, and maintained at 60° C. for 2 hrs. Then the prepared slurry was cooled to ambient temperature, and the pH was adjusted to about 9 using hydrochloric acid.

D: To 2850 grams of deionized water, 350 grams of cerium oxide with a median diameter (D50) of about 1.3 μm was added, under agitation at ambient conditions. The mixture was continuously mixed for 15 minutes to make a homogeneous suspension. To the suspension, 2500 g of water glass (potassium silicate with a mole ratio of 2:1) was introduced at ambient temperature. Then hydrochloric acid was used to adjust the pH to about 11. The resultant mixture was heated to 60° C. under autogenous conditions, and maintained at 60° C. for 2 hrs. Then the prepared slurry was cooled to ambient temperature, and the pH was adjusted to 4 using hydrochloric acid.

The resultant polishing slurries were used for glass polishing on SpeedFam 9B double-side polisher. Down force was 0.1 kg/cm2, lower platen speed was 30 RPM, and the rate of slurry flow was 200 ml/min. The glass removal rates of the polishing slurries respectively are A: 308, B: 721, C: 623, and D: 641 nm/min. There were no surface scratches and no slurry deposit on the polishing machine or polishing pads.

The resultant polishing slurries were also used for silicon wafer polishing on Logitech CDP polisher. Down force was 1 psi, lower platen speed and carrier speeds were 50 RPM, and the rate of slurry flow was 100 ml/min. The silicon wafer polishing removal rates respectively were A: 223, B: 249, C: 329, and D: 278 nm/min.

It will be apparent from the foregoing that while particular forms of the invention have been described, various modifications can be made without departing from the spirit and scope of the invention. Accordingly, it is not intended that the invention be limited, except as by the appended claims.

I claim:

1. A slurry for performing chemical mechanical planarization of a substrate, comprising:
abrasive particles selected from the group consisting of SiO₂, Al₂O₃, TiO₂, and CeO₂, and combinations thereof;
a silicate oligomer as a rate accelerator; and
water;
wherein the concentration of abrasive particles in the slurry is about 0.001% to about 50% by weight;
the concentration of silicate oligomer in the slurry is less than about 50% by weight; and
the concentration of water in the slurry is from about 20% to about 99% by weight.

2. The slurry of claim 1, wherein the concentration of abrasive particles in the slurry is about 0.001% to about 30% by weight.

3. The slurry of claim 1, wherein the silicate oligomer is selected from the group consisting of hydrolysis and condensation of silicates, silicon alkoxides, or precipitated silica, and combinations thereof.

4. The slurry of claim 1, wherein the silicate oligomer is selected from the group consisting of sodium silicate and potassium silicate.

5. The slurry of claim 1, further comprising a concentration of approximately from 0.0001 to 20% by weight of a dispersion agent in the slurry.

6. The slurry of claim 5, wherein the dispersion agent is selected from the group consisting of water soluble ionic and nonionic polymers, and combinations thereof.

7. The slurry of claim 5, wherein the dispersion agent is selected from the group consisting of phosphate or phosponic surfactants, organophosphate polymers, organophosphane polymers, silicone surfactants, ammonium surfactants, polyethylene oxide, polypropylene oxide, ethylene oxide, polypropylene oxide-ethylene oxide copolymers, polypropylene oxide alkyl or block polypropylene oxide-ethylene oxide surfactants, polyacrylates, polyamides, poly(methyl acrylate), poly(methyl methacrylate), polyacrylamide, and combinations thereof.

8. The slurry of claim 1, wherein the slurry has a pH of approximately 4 to 12.

9. The slurry of claim 1, wherein the slurry has a pH of about 7 to about 10.

10. The slurry of claim 1, wherein the slurry further comprises up to about 5% by weight of an oxidizer selected from the group consisting of perborate, persulfate, periodate, permanganate, urea-peroxide, hydroxylamine, and combinations thereof.

11. A method of preparing a slurry for performing chemical mechanical planarization of a substrate, comprising the steps of:
mixing water, abrasive particles and a silicate oligomer to form a mixture, wherein the concentration of abrasive particles in the slurry is about 0.001% to about 50% by weight, the concentration of silicate oligomer in the slurry is less than about 50% by weight, and the concentration of water in the slurry is from about 20% to about 99% by weight, and the abrasive particles are selected from the group consisting of SiO₂, Al₂O₃, TiO₂, and CeO₂, and combinations thereof;
adjusting the pH of the mixture to a pH in the range of about 10 to 11;
heating the mixture to a temperature of about 80° C. or less;
cooling the mixture to approximately ambient temperature; and
adjusting the pH of the mixture to about 4 to 11 to form the slurry.

12. The method of claim 11, wherein the concentration of abrasive particles in the slurry is about 0.001% to about 30% by weight.

13. The method of claim 11, wherein the silicate oligomer is selected from the group consisting of hydrolysis and condensation of silicates, silicon alkoxides, or precipitated silica, and combinations thereof.

14. The method of claim 11, wherein the silicate oligomer is selected from the group consisting of sodium silicate and potassium silicate.

15. The method of claim 11, further comprising adding a concentration of approximately from 0.0001 to 20% by weight of a dispersion agent to the slurry.

16. The method of claim 15, wherein the dispersion agent is selected from the group consisting of water soluble ionic and nonionic polymers, and combinations thereof.

17. The method of claim 15, wherein the dispersion agent is selected from the group consisting of phosphate or phosponic surfactants, silicone surfactants, ammonium surfactants, polyethylene oxide or polypropylene oxide alkyl or block polypropylene oxide-ethylene oxide surfactants, poly(methyl acrylate), poly(methyl methacrylate), polyacrylamide, and combinations thereof.

18. The method of claim 11, wherein the slurry has a pH of approximately 4 to 12.

19. The method of claim 11, wherein the slurry has a pH of about 7 to about 10.

20. The method of claim 11, further comprising adding to the slurry up to about 5% by weight of an oxidizer selected from the group consisting of perborate, persulfate, periodate, permanganate, urea-peroxide, hydroxylamine, and combinations thereof.

21. The method of claim 11, wherein the step of heating the mixture to a temperature of about 80° C. or less comprises heating the mixture to a temperature of about 60° C. or less, and maintaining the temperature of the mixture at about 60° C. from about 0.1-6 hours.

22. A method of polishing a surface of a substrate with a slurry for performing chemical mechanical planarization, comprising the steps of:
providing a slurry comprising abrasive particles selected from the group consisting of SiO₂, Al₂O₃, TiO₂, and CeO₂, and combinations thereof; a silicate oligomer as a rate accelerator;
and water; wherein the concentration of abrasive particles in the slurry is about 0.001% to about 50% by weight; the concentration of silicate oligomer in the slurry is less than about 50% by weight; and the concentration of water in the slurry is from about 20% to about 99% by weight;
applying the slurry to a polishing pad; and
polishing the surface of the substrate with the slurry and the polishing pad.

23. The method of claim 22, wherein the concentration of abrasive particles in the slurry is about 0.001% to about 30% by weight.

24. The method of claim 22, wherein the silicate oligomer is selected from the group consisting of hydrolysis and condensation of silicates, silicon alkoxides, or precipitated silica, and combinations thereof.

25. The method of claim 22, wherein the silicate oligomer is selected from the group consisting of sodium silicate and potassium silicate.

26. The method of claim 22, further comprising adding a concentration of approximately from 0.0001 to 20% by weight of a dispersion agent to the slurry.

27. The method of claim 26, wherein the dispersion agent is selected from the group consisting of water soluble ionic and nonionic polymers, and combinations thereof.

28. The method of claim 26, wherein the dispersion agent is selected from the group consisting of phosphate or phosponic surfactants, silicone surfactants, ammonium surfactants, polyethylene oxide or polypropylene oxide alkyl or block polypropylene oxide-ethylene oxide surfactants, poly(methyl acrylate), poly(methyl methacrylate), polyacrylamide, and combinations thereof.

29. The method of claim 22, wherein the slurry has a pH of approximately 4 to 12.

30. The method of claim 22, wherein the slurry has a pH of about 7 to about 10.

31. The method of claim 22, further comprising adding to the slurry up to about 5% by weight of an oxidizer selected from the group consisting of perborate, persulfate, periodate, permanganate, urea-peroxide, hydroxylamine, and combinations thereof.
